(19) United States
(12) Patent Application Publication
(10) Pub. No.: US 2018/0209175 A1
(43) Pub. Date: Jul. 26, 2018

(54) SECURING MECHANISM FOR A SLIDING PANEL

(71) Applicant: Dan Raz Ltd., Tirat Carmel (IL)

(72) Inventor: Amir RAZ, Haifa (IL)

(21) Appl. No.: 15/745,440

(22) PCT Filed: Jun. 23, 2016
(86) PCT No.: PCT/IL2016/050671

§ 371 Date: Jan. 17, 2018

Related U.S. Application Data
(60) Provisional application No. 62/208,856, filed on Aug. 24, 2015.

(51) Int. Cl. E05B 63/00; E05B 65/08; E05C 19/00; E05C 3/12; E05C 3/14

(52) U.S. Cl. CPC E05B 63/0052; E05B 65/0852; E05C 3/14; E05C 19/007; E05C 3/124; E05C 19/002

(57) ABSTRACT

A sliding door is provided including a panel configured to slide along a path; a holding member transversely disposed with respect to the path in a location along the path, the holding member defining a channel configured for receiving therein at least a segment of the panel, the holding member further including an abutting portion transversely extending inside the channel defining an opening configured to allow sliding of the segment therethrough; and a stop member being displaceable between an engaged state in which a first end of the stop member engages the abutting portion and the first side portion of the holding member, and a second end of the stop member engages the segment precluding thereby sliding of the panel at least in a direction towards the abutting portion and a disengaged state in which the stop member disengages the segment allowing thereby sliding the panel towards the abutting portion.

### FIELD OF INVENTION

The presently disclosed subject matter relates to securing mechanism for a sliding panel, in general, and in particular to a securing mechanism for securing a sliding panel of a sliding door or a window.

### BACKGROUND

Securing mechanism for a sliding panel are known, for example U.S. Pat. No. 4,062,576 discloses a device which locks the sliding panel against horizontal and vertical movement. The device is secured on one of the upraised walls of the panel track by an eccentric that works in opposition to a support flange. The support flange carries slide stops to prevent the panel from sliding in its track. The vertical movement of the window out of the track is prevented by a lift stop comprising a flat spring secured in the upper track or lift stop elements on the support flange

U.S. Pat. No. 4,300,795 discloses an apparatus which includes a lock unit having dual eccentrics that are spring biased toward an opposing planar support flange. The lock unit is mounted so that a selected sidewall of a conventional sliding panel track is squeezed between the eccentrics and the support flange by the force of the spring. Slide stops extend from the support flange into the operative area of the track to prevent horizontal sliding movement of the panel. The apparatus further includes a lift stop which may be used in conjunction with the lock unit to prevent the sliding panel from being lifted clear of the lower track. It comprises a flat spring having a bias toward assuming a U-shaped configuration. The spring legs are spread so that the spring can be inserted into the upper panel track above the panel.

AU199186932 discloses a locking mechanism for sliding sash windows comprises an anchor and a latch. The latch comprises a shaped channel, one limb of which has formed therealong a bead for slidably and pivotally engaging a trailing edge of the sliding sash The channel further comprises a central relief portion within which the anchor seats and, adjacent a bottom surface, a projecting lip which is adapted to engage a step formed on the centre mullion of the window. The anchor comprises a body which is adapted to slidably engage the trailing edge of the sliding sash and which further comprises a bore which receives a locking cylinder from which protrudes a rearwardly facing tab In a first, locked position, the channel is inhibited in pivoting with respect to the anchor owing to an interference between the channel and the tab In a second, unlocked position, the channel is free to pivot with respect to the anchor so that the lip can pivot free of the step so that the sliding sash can be opened or closed. In order for the window to automatically latch when closed, a spring is provided integrally with the channel which biases against a platform on the anchor to bias the channel into the first position

### SUMMARY OF INVENTION

There is provided in accordance with an example of the presently disclosed subject matter a sliding door including a panel configured to slide along a path; a holding member transversely disposed with respect to the path in a location along the path, the holding member having a first side portion coupled to a second side portion, the second side portion being spaced apart from the first side portion defining thereby a channel therebetween, the channel being configured for receiving therein at least a segment of the panel, the holding member further including an abutting portion transversely extending inside the channel from the first side portion defining an opening between an edge thereof and the second side portion, the opening being configured to allow sliding of the segment therethrough; and a stop member being displaceable between an engaged state in which a first end of the stop member engages the abutting portion and the first side portion, and a second end of the stop member engages the segment precluding thereby sliding of the panel at least in a direction towards the abutting portion and a disengaged state in which the stop member disengages the segment allowing thereby sliding of the panel towards the abutting portion.

The stop member can be configured such that in the engaged state compressive forces are exerted on the segment and the stop member whereby sliding of the panel towards the abutting portion can be opposed. The path can extend along an opening defined by at least one profile. The holding member can be a longitudinal member integrally formed with the at least one profile.

The stop member can be an elongated rod disposed inside the channel along the length thereof and configured to engage, in the engaged state, at least a portion of the segment. The segment can be an edge of the panel extending along one dimension of the panel, the dimension transversely disposed with respect to the path, and wherein the elongated rod can be configured to engage at least the majority of the edge.

The stop member can include a cross section having a rotational asymmetry configured such that the stop member can be rotated between a first orientation, in which the stop member can be in the disengaged state, and a second orientation, in which the stop member can be in the engaged state. The stop member can be rotatably mounted on a hinge such that an axis of rotation thereof can be in parallel with an axis of the rotational asymmetry.

The stop member can include a rectangular cross section and can be configured to be rotated about an axis between the first orientation and the second orientation, and wherein in the second orientation the rectangular cross section can be disposed in an angle with respect to the panel such that a first end of the rectangular cross section engages the abutting portion and the first side portion while a second end of the rectangular cross section engages the segment of the panel.

The stop member can include an asymmetric oval cross section having a first end configured to abut the abutting portion and the first side portion, and a second end configured to abut the segment. The asymmetric oval cross section can include a circular portion defined at the first end and a protruding portion defined at the second end, the protruding portion being configured to selectively engage the segment. The segment can include an engaging edge having a depression configured to engage the protruding portion. The abutting portion and the first side portion define together a rounded seat configured to rotatably hold therein the circular portion.

The segment can include a shoulder portion facing the stop member and being configured such that in the engaged state a second end of the stop member engages the shoulder portion.

The sliding door can further include a return mechanism bearing against the stop member and being configured to urge the stop member to the engaged state.

The sliding door can further include a handle so disposed with respect to the stop member such that it can be configured for actuating the displacement of the stop member from the engaged state to the disengaged state. The handle can be mounted on the panel adjacent the segment, and can be configured to actuate displacement of the stop member from the engaged state to the disengaged state.

There is provided in accordance with a further aspect of the presently disclosed subject matter a securing mechanism for securing a segment of a panel of a sliding door configured to slide along a path. The securing mechanism including a holding member transversely disposed with respect to the path in a location along the path, the holding member having a first side portion coupled to a second side portion, the second side portion being spaced apart from the first side portion defining thereby a channel therebetween, the channel being configured for receiving therein at least the segment of the panel, the holding member further including an abutting portion transversely extending inside the channel from the first side portion defining an opening between an edge thereof and the second side portion, the opening being configured to allow sliding of the segment therethrough; and a stop member being displaceable between an engaged state in which a first end of the stop member engages the abutting portion and the first side portion and a second end of the stop member can be configured to engage the segment precluding thereby sliding of the panel at least in a direction towards the abutting portion and a disengaged state in which the stop member can be configured to disengage the segment allowing thereby sliding of the panel towards the abutting portion; the stop member can be configured such that in the engaged state compressive forces are exerted on the segment and the stop member whereby sliding of the panel towards the abutting portion can be opposed.

There is provided in accordance with yet another aspect of the presently disclosed subject matter a sliding door comprising: a panel configured to slide along a path; a stop member transversely disposed with respect to the path adjacent a location along the path, the stop member being pivotally mounted on an axis, and being displaceable between an engaged state in which the stop member engages a segment of the panel precluding thereby sliding of the panel and a disengaged state in which the stop member disengages the segment allowing thereby sliding of the panel; wherein the stop member can be configured such that in the engaged state compressive forces are exerted on the segment by the stop member whereby sliding of the panel towards the abutting portion can be opposed.

The stop member can be mounted on the panel and configured to slide therewith along the path; and wherein the sliding door further can include a holding member transversely disposed with respect to the path in a location along the path, the holding member having a first side portion coupled to a second side portion, the second side portion being spaced apart from the first side portion defining thereby a channel therebetween, the channel being configured for receiving therein at least the segment of the panel, the holding member further including an abutting portion transversely extending inside the channel from the first side portion defining an opening between an edge thereof and the second side portion, the opening being configured to allow sliding of the segment therethrough; and wherein in the engaged state first end of the stop member engages the abutting portion and the first side portion and a second end of the stop member engages the segment precluding thereby sliding of the panel at least in a direction towards the abutting portion, and wherein in the disengaged state the stop member can be configured to disengage the segment allowing thereby sliding of the panel towards the abutting portion.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1A is a perspective view of a sliding panel having a securing mechanism in accordance with an example of the presently disclosed subject matter;

FIG. 2A is a top view of the side profile of the sliding panel of FIG. 1A;

FIG. 2B is a perspective view of stop member of the securing mechanism of FIG. 1A;

FIG. 3A is a sectional view of the sliding panel of FIG. 1A taken along lines A-A, wherein the securing mechanism is in the secured position thereof;

FIG. 3B is a sectional view of the sliding panel of FIG. 1A taken along lines A-A, wherein the securing mechanism is in the released position thereof;

FIG. 3C is a sectional view of the sliding panel of FIG. 1A taken along lines A-A, wherein the panel is in the open position thereof;

FIG. 4A is an enlarged view of the holding member of FIG. 3A;

FIG. 4B is an enlarged view of the holding member of FIG. 3B;

FIG. 4C is an enlarged view of the holding member of FIG. 3C;

FIG. 5A is a perspective view of a sliding panel having a securing mechanism in accordance with another example of the presently disclosed subject matter;

FIG. 5B is a top view of the sliding panel of FIG. 5A;

FIG. 5C is a perspective view of stop member of the securing mechanism of FIG. 5A;

FIG. 6A is a sectional view of the sliding panel of FIG. 5A taken along lines A-A, wherein the securing mechanism is in the secured position thereof;

FIG. 6B is a sectional view of the sliding panel of FIG. 5A taken along lines A-A, wherein the securing mechanism is in the released position thereof;

FIG. 6C is a sectional view of the sliding panel of FIG. 5A taken along lines A-A, wherein the panel is in the open position thereof;

FIG. 7A is an enlarged view of the holding member of FIG. 6A;

FIG. 7B is an enlarged view of the holding member of FIG. 6B;

FIG. 7C is an enlarged view of the holding member of FIG. 6C;

FIG. 8A is a top sectional view of a sliding panel having a securing mechanism in accordance with yet another example of the presently disclosed subject matter;

FIG. 8B is an enlarged view of the holding member of FIG. 8A in the secured position thereof; and

FIG. 8C is an enlarged view of the holding member of FIG. 8A, is in the released position thereof.

### DETAILED DESCRIPTION OF EMBODIMENTS

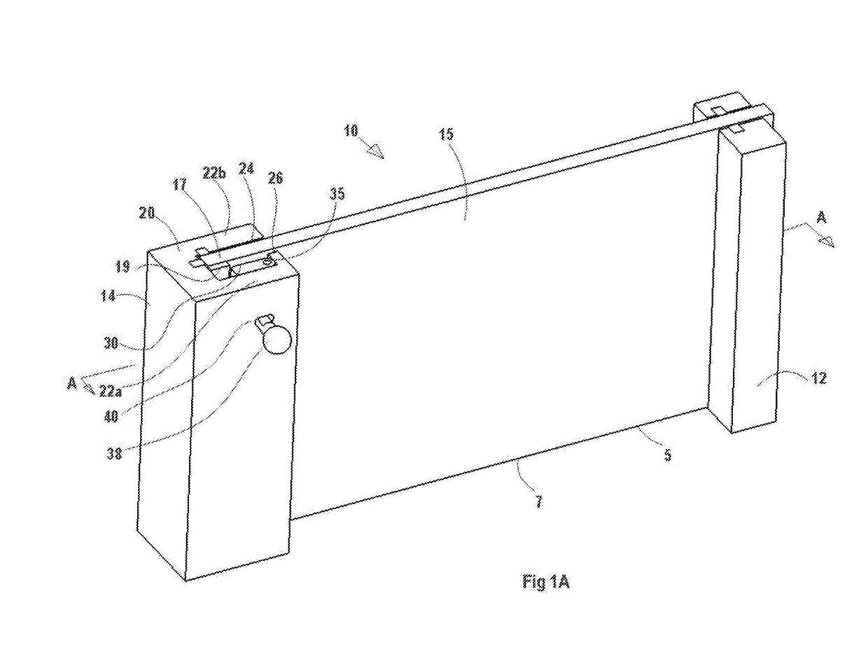

FIGS. 1A to 1B show a sliding door 10 for closing an opening 5, defined between a first profile 12 and a second profile 14. According to the illustrated example the first and second profiles 12 and 14, are vertically disposed with respect to the opening 5. The sliding door 10 includes a panel 15 configured to slide along a path 7 defined between the first profile 12 and the second profile 14.

It is appreciated that according to other examples the opening can be defined between two wall portions, as opposed to two profiles. In addition, the sliding door 10 can be configured to slide along a path 7 which is not defined at an opening, rather the path can be defined between two points, such that the panel 15 can be slide to de disposed between the two points, precluding thereby crossing through the area defined by path.

According to a further example, the sliding door 10 can include two panels extending along a path on an opening having a first side profile one on side thereof and a second side profile on another side thereof. The panels can be disposed to slide along the opening as a side-by-side sliding window. According to this example, each panel can be configured to abut against one side profile while the opposing edge of the panel is disposed adjacent the other panel.

The sliding door 10 further includes a holding member 20 which can be a longitudinal member having a first side portion 22a coupled to a second side portion 22b and being spaced apart from the first side portion 22a defining thereby a channel 24 therebetween. The channel 24 is configured for receiving therein at least a segment 17 of the panel 15.

The holding member 20 is transversely disposed with respect to the path 7 in a location along path 7. That is to say, if, for example, the path 7 substantially horizontally extends along a doorway, and the panel 15 is configured to close the doorway by selectively sliding rightward and leftward, the holding member 20 is substantially vertically disposed at any point along the path 7. The holding member 20 is so disposed along the path such that when the panel 15 slid and reaches the holding member 20 a segment 17 thereof slides through the channel 24. The holding member 20 can extend along the height of the panel, such that substantially the entire edge segment of the panel 15 can be disposed inside the channel 24.

According to the illustrated example, the holding member 20 is integrally formed with the second profile 14, such that the holding member 20 is disposed adjacent the edge of the path 7, i.e. the jamb of the doorway.

According to other examples, however, the holding member 20 can be disposed at any other location along the path 7, such as adjacent the first profile 12, or spaced apart from the first or second profiles 12 and 14.

According to other examples, the path 7 can vertically extends, for example along an opening of a window and the panel 15 can be configured to close the opening, by selectively sliding upwardly and downwardly, such as vertical sliding window. According to this example, the holding member 20 can be substantially horizontally disposed at any point along the path 7. Similar to the previous example, the holding member 20 is so disposed along the vertical path such that when the panel 15 slid and reaches the holding member 20 a segment 17 thereof slides through the channel 24.

According to this example, the first profile 12 is mounted at the top of the opening of the vertical sliding window while the second profile 14 is mounted at the bottom of the opening of the vertical sliding window. The holding member 20 can be coupled to the second profile 14, such that the holding member 20 is disposed adjacent the edge of the path 7, i.e. the bottom of the window.

It is noted that in this example, the holding member 20 can extend along the width of the panel 15, such that substantially the entire edge segment of the panel 15 can be disposed inside the channel 24.

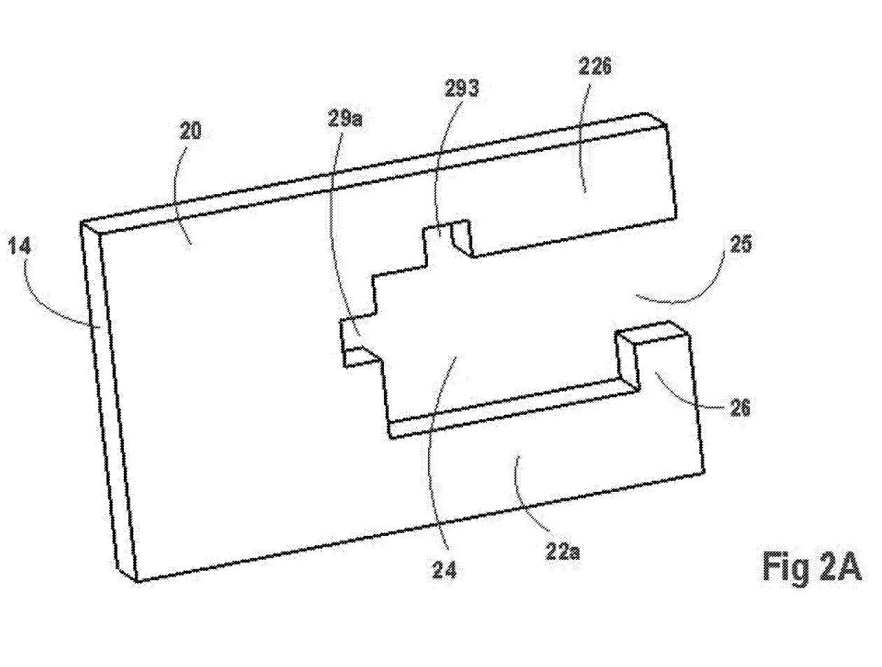

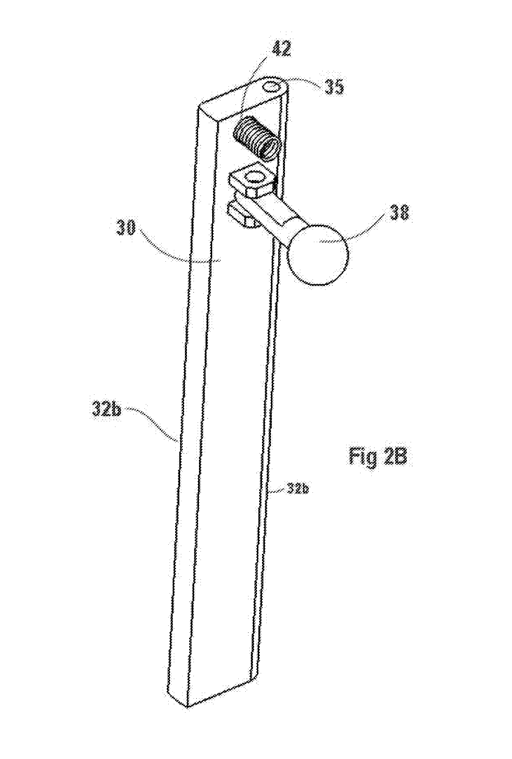

As can best be seen in FIG. 2A, the holding member 20 further includes an abutting portion 26 transversely extending inside the channel 24 from the first side portion 22a defining an opening 25 between an edge thereof and the second side portion 22b. The opening 25 is configured to allow sliding of the segment 17 therethrough into the channel 24.

It is appreciated that in case the holding member 20 is mounted away from the first and second profiles 12 and 14 the opening 25 and channel 24 are configured such that the panel 15 can be slid therethrough from the first profile 12 towards the second profile 14 and vice versa. Thus the width of the opening 25, i.e. the distance between the edge of the abutting portion 26 and the second side portion 22b, is configured to allow sliding the panel therethrough.

The sliding door 10 further includes a stop member 30 disposed in the channel 24 such that it engages the abutting portion 26 and the first side portion 22a.

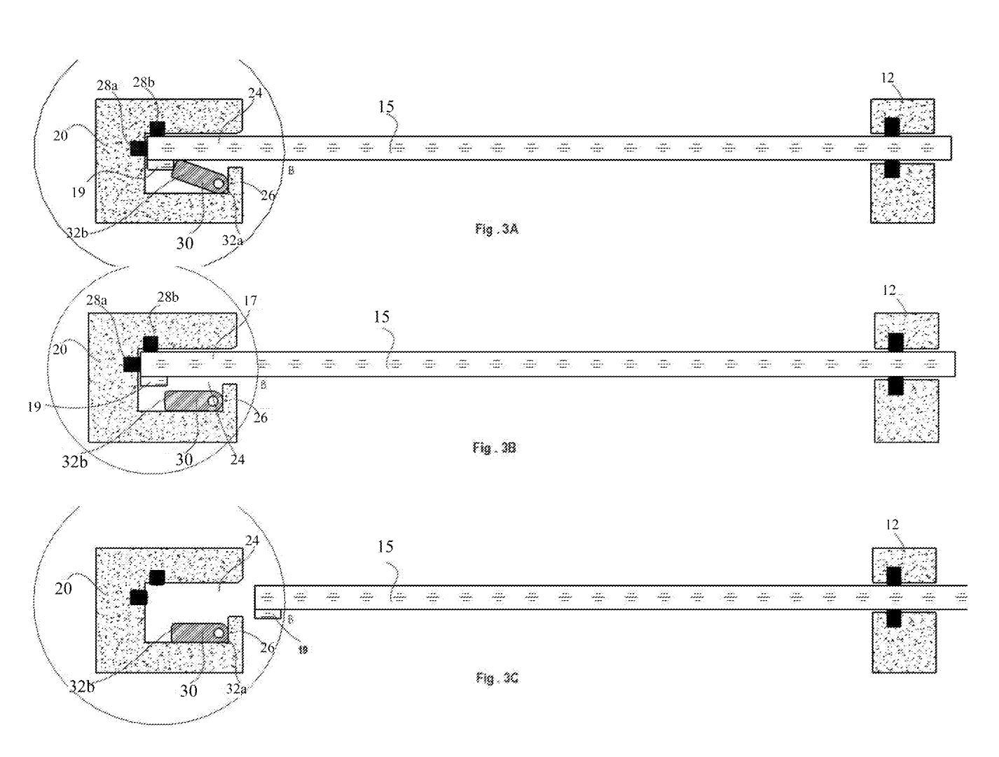

In the present example the segment is an edge of the panel extending along one dimension of the panel, for example the height thereof. The dimension is transversely disposed with respect to the path. Similarly the holding member 20 and the channel 24 extend along the height of the panel 15, thus, the stop member 30 can be an elongated rod disposed inside the channel 24 along the length thereof. The stop member 30 can thus be configured to engage the majority or the entire length of the abutting portion 26 and the first side portion 22a. As shown in FIGS. 2A and 3A, the second profile 14 includes a sealing element 28a which can be disposed in a groove 29a (best seen in FIG. 2A) defined inside the channel 24. The groove 29a is defined such that the sealing element 28a is aligned with the path 7 along which the panel 15 slides. This way, the edge of the panel 15 is configured to abut the sealing element 28a, precluding air flow therebetween. Similarly, the second side portion 22b includes a sealing element 28b which can be disposed in a groove 29b defined inside the channel 24 and being configured to abut the face of the segment of the panel 15.

It is appreciated that the sealing elements 28a and 28b can be replaced with a shock absorbing members, or can be configured to provide sealing and shock absorbent, which can disposed inside the grooves 29a and 29b. The shock absorbing element can be disposed in the groove 29a (best seen in FIG. 2A) such that the shock absorbing element is aligned with the path 7 along which the panel 15 slides. This way, the edge of the panel 15 is configured to abut the shock absorbing element 28a, providing protection thereto. Similarly, the second side portion 22b can include a shock absorbing element which can be disposed in a groove 29b defined inside the channel 24 and being configured to abut the face of the segment of the panel 15. As shown in FIG. 2B, the stop member 30 according to the illustrated example has a rectangular cross section having a first end 32a configured to abut the abutting portion 26 and the first side portion 22a, and a second end 32b configured to abut the segment 17 of the panel 15.

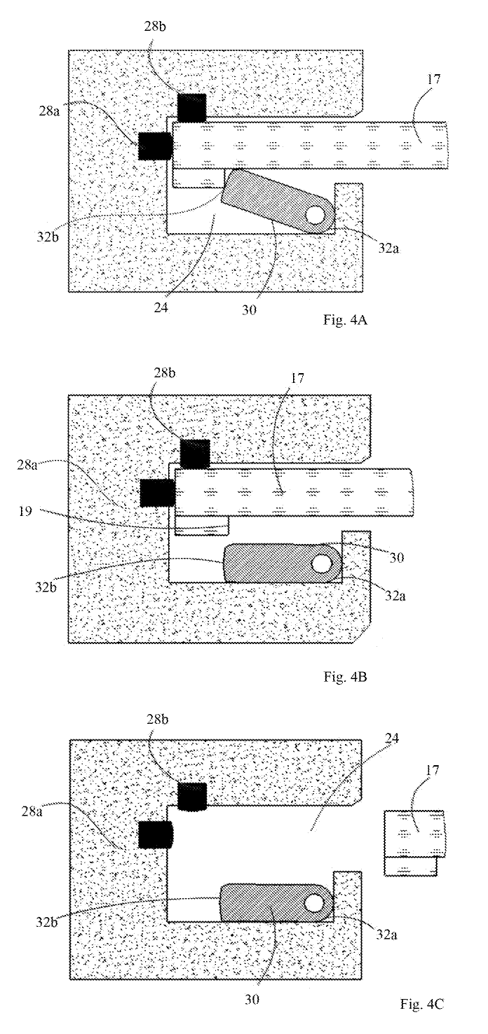

Attention is now made to FIGS. 3A through 4C, the stop member 30 is displaceable within the channel 24 between an engaged state in which the second end 32b of stop member 30 engages the segment 17 of the channel 15 (FIGS. 3A and 4A) and a disengaged state in which the second end 32b of the stop member 30 disengages the segment 17 (FIGS. 3B and 4B).

In the illustrated example, the rectangular stop member 30 is configured to be rotated about an axis between the disengaged states and the engaged state. Accordingly, in the disengaged state, as shown in FIG. 3B the rectangular cross section of the stop member 30 is disposed substantially in parallel to the segment 17, such that the edge segment 17 of the panel 15 can slide inside or through the channel 24. In the engaged state, however, the rectangular cross section of the stop member 30 is disposed in an angle with respect to the panel 15 such that the first end 32a thereof engages the abutting portion 26 and the first side portion 25, while the second end 32b thereof engages the segment 17 of the panel 15.

According to this example, the edge segment 17 of the panel can include a shoulder portion 19 protruding from the surface of the panel 15 towards the stop member 30. The shoulder portion 19 is configured such that in the engaged state of the stop member 30, the second end 32b thereof engages the segment 17 and the shoulder portion 19. The stop member 30 is thus configured such that in the engaged state compressive forces are exerted on the segment 17 and the shoulder portion 19 and the stop member 30. The compressive forces according to this example are formed in the engaged state between the corner of the first side portion 22a and the abutting portion 26, on one hand and the second side portion 22b on the other hand, while a segment of the panel 15 and the stop member 30 are securely held therebetween.

As a result, in the engaged state sliding of the panel 15 towards the abutting portion 26 is opposed, such that the securing mechanism is in the secured position and the panel is locked in place. In this position, the segment 17 which is pushed by the stop member 30 towards the second side portion 22b can abut the sealing element 28b on the second side portion 22b. In the disengaged state however, the securing mechanism is released and the panel is free to slide towards the abutting portion 26 and out of the channel 24, and consequently to the open position of the door, as shown in FIGS. 3C and 4C.

It is appreciated that displacement of the stop member 30 between an engaged and disengaged states can be a rotation thereof about a fixed axis, as in the present example, or otherwise the displacement can be a lateral movement thereof. It is further appreciated that in the case of a rotational displacement, the stop member includes a cross section having a rotational asymmetry. The rotational asymmetry is configured such the stop member 30 can be rotated between a first and a second orientations. In the first orientation of the stop member a portion thereof engages the segment of the panel, while in a second orientation of the stop member it disengages the panel.

It is appreciated that either in the example of a lateral displacement of the stop member 30 or in the example of a rotational displacement thereof, the abutting portion 26 and the first side portion 22b are configured such that stop member 30 maintains an engagement therewith at least in the engaged state. This way, in the engaged state the stop member 30 and the segment 17 of the panel 15 are compressed between the first side portion 22a and the abutting portion 26, on one hand and the second side portion 22b on the other hand.

As indicated hereinabove, in the present example the holding member 20, the channel 24, and the stop member 30 extend along the height of the panel 15, such that the stop member 30 engages the entire height of the panel, or at least large portions thereof. It is appreciated that engaging large portion of the panel facilitate securing thereof in place, without exerting major forces in one location, i.e the forces exerted on the panel are spread along portions of the height thereof.

The stop member 30, according to the example of FIGS. 1A and 1B, can be pivotally mounted on a hinge 35 disposed close the first end 32a thereof and secured to the holding member 20 adjacent the corner of the abutting portion 26 and the first side portion 22a. The hinge 35 facilitate the rotation of the stop member 30 between the engaged and disengaged states.

It is appreciated that according to other examples the hinge 35 can be mounted elsewhere inside the channel 24 so long as the stop member 30 can be rotated between the engaged in which sliding of the panel 15 towards the abutting portion 26 is opposed, and a disengaged states in which the panel is free to slide towards the abutting portion 26 and out of the channel 24.

It is appreciated that the axis of rotation of the stop member 30 can be defined away from the first end 32a thereof, so long as the engaged and disengaged states are maintained as described herein above.

Displacement of the stop member 30 between the engaged and disengaged states can be carried out by a handle 38 coupled thereto. The handle 38 can be configured to protrude out of the channel 24 through a bore 40 facilitating thereby displacement of the stop member 30. According to the example illustrated in FIG. 2B, the handle 38 is mounted to the stop member 30 in close proximity to the second end 32b thereof while the hinge 35 is mounted in close proximity to the first end 32a thereof. This way, rotation of the stop member 30 about the hinge 35 is facilitated by the handle 38.

The stop member 30 can be further provided with return mechanism, such as a spring 42 configured to urge the stop member 30 to be normally disposed at the engaged state thereof. The spring 42 is configured such that one end thereof bears against the inner surface of the first side portion 22a, while the opposing end thereof bears against the stop member 30.

This way, the panel 15 can be slide along the path 7 such that the edge segment 17 thereof is inserted into the channel 24. The edge of the panel 15 engage the stop member 30 which is urged to the engaged state thereof, i.e. is disposed in diagonal inside the channel, having an angle with respect to the panel 15. Thus, the shoulder portion 19 at the edge segment 17 of the panel IS pushes the stop member 30 towards the first side portion 22a, against the force exerted by the spring 42. Once the edge segment 17 with the shoulder portion 19 are fully inserted inside the channel 24, passed the second end 32b, the stop member 30 is free to be urged back by the spring to the enraged position thereof. At this position the panel 15 is secured by the stop member 30 and cannot be slid in the direction towards the opening 25 of the channel. This way, in a case of a sliding door, the door is closed and locked. Unlocking the door can be carried out by pulling the handle 38 through the bore 40 overcoming the forces exerted by the spring 42 and displacing the stop member 30 to the disengage state thereof. This way the shoulder portion 19 and the edge segment 17 are no longer engaged by the second end 32b, the stop member 30, and the panel is free to be slid towards the first profile, i.e. opening the door or the window.

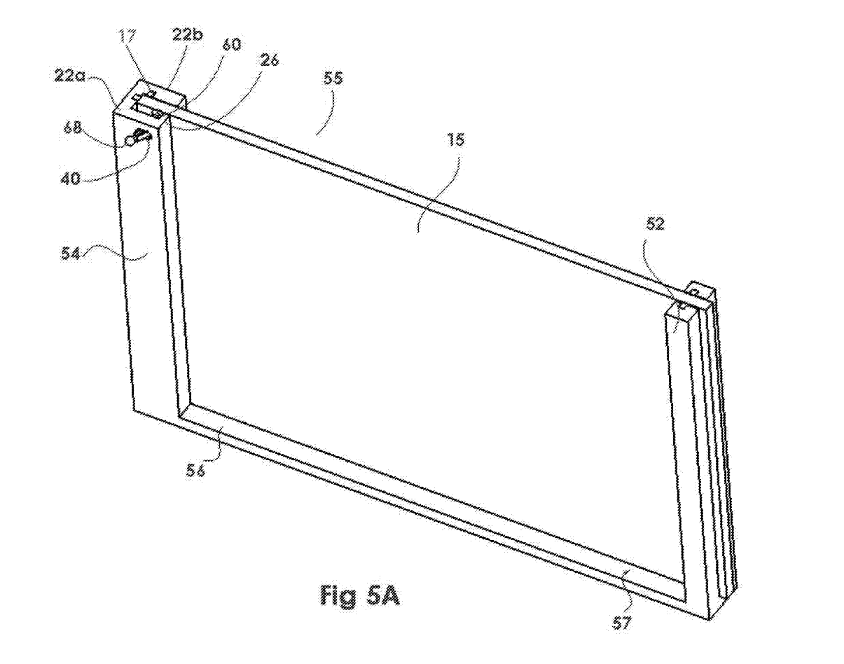

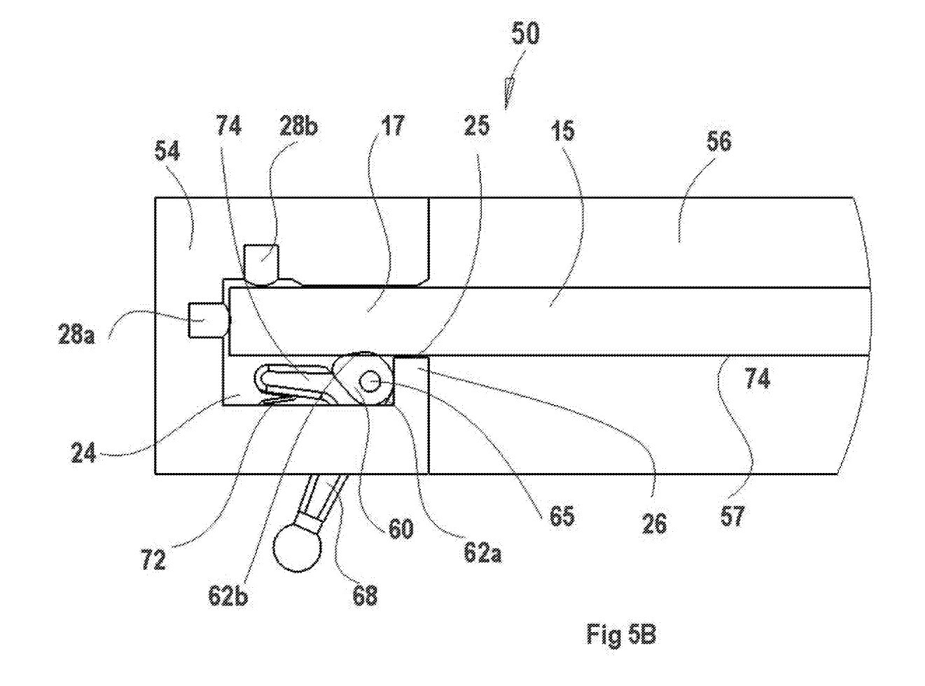

Reference is now made to FIG. 5, showing a sliding door 50 having a stop member in accordance with another example of the presently disclosed subject matter. The sliding door 50, for which the same elements as in the previous example are designated with the same reference numerals, is configured for closing an opening 55, such as a window, defined between a first profile 52 and a second profile 54. According to the illustrated example the opening further includes a bottom profile 56 disposed between the bottom edge of the first profile 52 and the bottom edge of the second profile 54. The bottom profile 56 defines a path 57 along which the panel 15 can slide. The path 57, according to the present example, is an elongated groove defined in the bottom profile 56 and extending between the first profile 52 and a second profile 54 such that he panel 15 can slide therein.

The sliding door 50 further includes a holding member 20 which can be identical to the one shown in FIGS. 1A through 2A, and can be a longitudinal member integrally formed with the second profile 54, and can include a first side portion 22a coupled to a second side portion 22b and being spaced apart from the first side portion 22a defining thereby a channel 24 therebetween. The channel 24 is configured for receiving therein at least a segment 17 of the panel 15, which according to the present example can be provided without a shoulder portion

As in the previous example, the holding member 20 further includes an abutting portion 26 transversely extending inside the channel 24 from the first side portion 22a defining an opening 25 between an edge thereof and the second side portion 22b. The opening 25 is configured to allow sliding of the segment 17 therethrough into the channel 24.

The sliding door 50 further includes a stop member 60 disposed in the channel 24 such that it engages the abutting portion 26 and the first side portion 22a.

As shown in FIGS. 5B and 5C, the stop member 60 according to the illustrated example has an asymmetric oval cross section having a first end 62a configured to abut the abutting portion 26 and the first side portion 22a, and a second end 62b configured to abut the segment 17 of the panel 15. The asymmetric oval cross section of the stop member 60 has a rotational asymmetry which is configured such the stop member 60 can be rotated between a first and a second orientations. In the first orientation of the stop member 60 the second end 62b thereof is configured to engage the edge segment 17 of the panel 15, while in a second orientation of the stop member 60 it is configured to disengage the panel.

According to the illustrated example the asymmetric oval cross section includes a circular portion defined first end 62a of the stop member 60 and a protruding portion defined at the second end 62b. The protruding portion is configured to selectively engage the segment 17 of the panel 15.

The stop member 60, according to the present example is pivotally mounted on a hinge 65 disposed close the first end 62a thereof and secured to the holding member 20 adjacent the corner of the abutting portion 26 and the first side portion 22a. It is appreciated that the hinge 65 is mounted such that the axis of rotation thereof is in parallel with an axis with respect to which the cross section of the stop member 60 has a rotational asymmetry. For example, the hinge 65 can be mounted at the center of the circular portion defined at the first end 62a of the stop member 60. The hinge 65, thus, facilitate the rotational displacement of the stop member 30, and selectively shifts the protruding portion defined on the second end 62b thereof between the engaged and disengaged states.

As shown in FIGS. 5A and 5B, the second profile 54 and the second side portion 22b can include sealing element 28a and 28b which, as in the previous example, can be disposed in grooves 29a and 29b defined inside the channel 24.

As in the previous example, the holding member 20 and the channel 24 can extend along the height of the panel 15, thus, the stop member 60 can be an elongated rod disposed inside the channel 24 along the length thereof. The stop member 60 can thus be configured to engage the entire length of the abutting portion 26 and the first side portion 22a.

As in the previous example, the displacement of the stop member 60 between the engaged and disengaged states can be carried out by a handle 68 coupled thereto. The handle 68 can be configured to protrude out of the channel 24 through an elongated bore 40 facilitating thereby displacement of the stop member 60. According to the illustrated example the handle 68 is coupled to the first end 62a, i.e. the circular portion of the stop member 60. This way sideward displacement of the handle 68 through the elongated bore 40 causes the rotation of the stop member 60 about the hinge 65 such that the second end 62b is selectively shifted between the engaging state and the disengaging state.

The stop member 60 can be further provided with return mechanism, such as a spring 72 configured to urge the stop member 60 to be normally disposed at the engaged state thereof. The spring 72 is configured such that one end thereof bears against the inner surface of the first side portion 22a, while the opposing end thereof bears against a bearing protrusion 74 extending from the stop member 30.

It is appreciated that the handle according to another example, can be mounted on the panel and can be configured to actuate the displacement of the stop member. For example, the handle can be configured to displace the stop member to the disengaged state thereof such that the panel can be slid. According to an example, the handle can be configured such that actuation of the stop member is carried out by pulling the handle in the sliding direction of the panel along the path. For example, the handle can be configured to be pulled in the same direction as the sliding of the panel when the sliding door is opened.

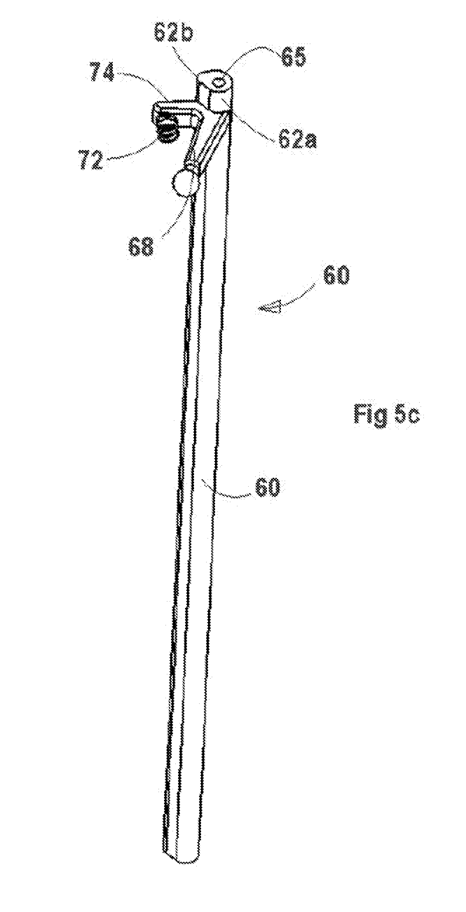

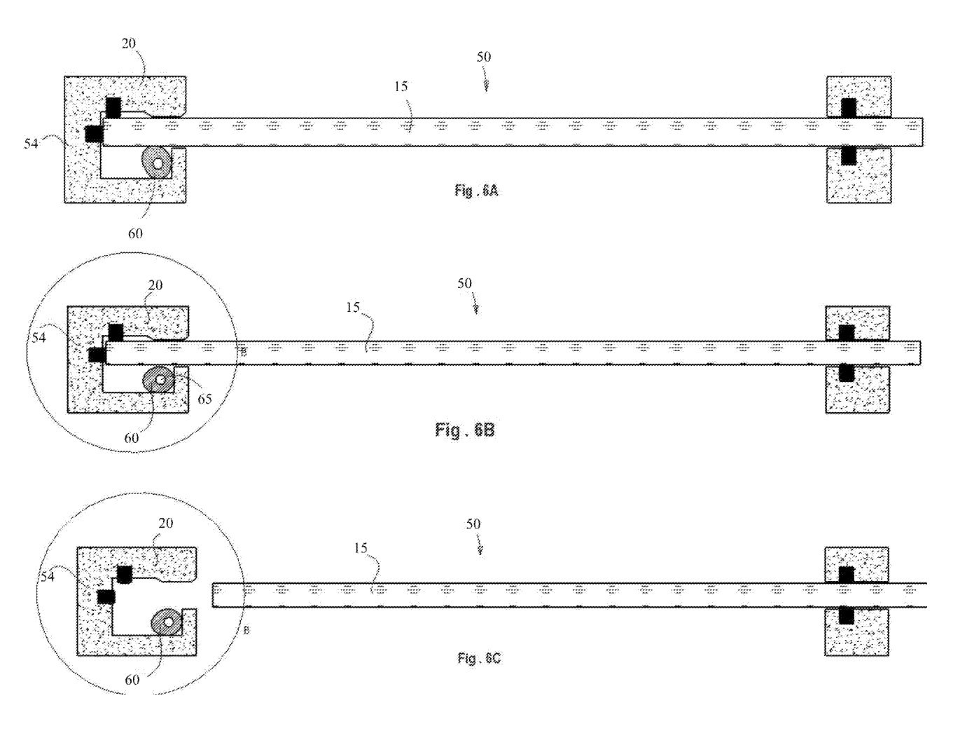

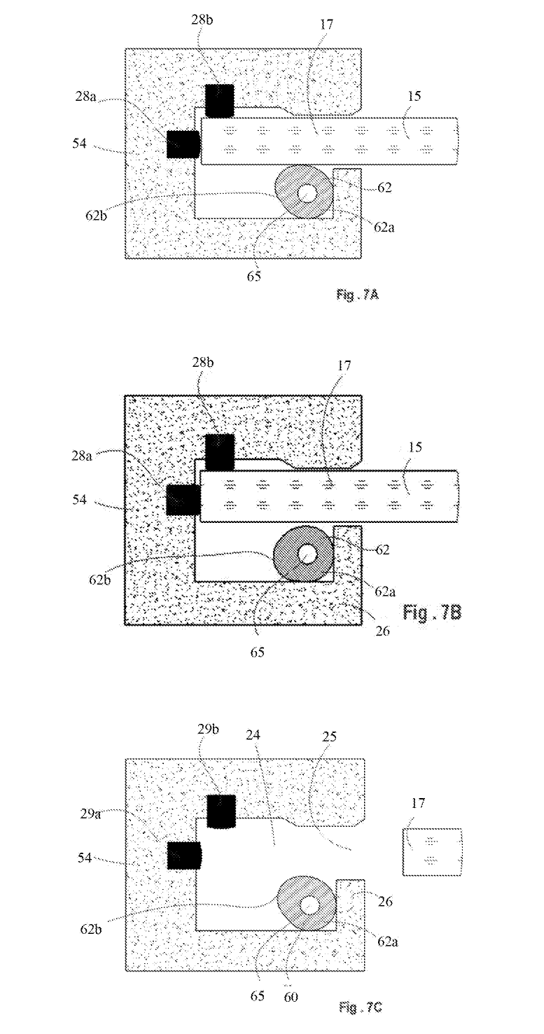

Attention is now made to FIGS. 6A through 7C, the stop member 60 is displaceable within the channel 24 between an engaged state in which the protruding portion at the second end 62b of stop member 60 engages the segment 17 of the channel 15 (FIGS. 6A and 7A) and a disengaged state in which the protruding portion at the second end 62b of stop member 60 disengages the segment 17 (FIGS. 6B and 7B).

As a result, in the engaged state sliding of the panel 15 towards the abutting portion 26 is opposed, such that the panel is locked in place. In this position, the segment 17 which is urged by the protruding portion at the second end 62b of the stop member 60 towards the second side portion 22b can abut the shock absorbing element 28b on the second side portion 22b. In the disengaged state however the panel is free to slide towards the abutting portion 26 and out of the channel 24, as shown in FIGS. 6C and 7C.

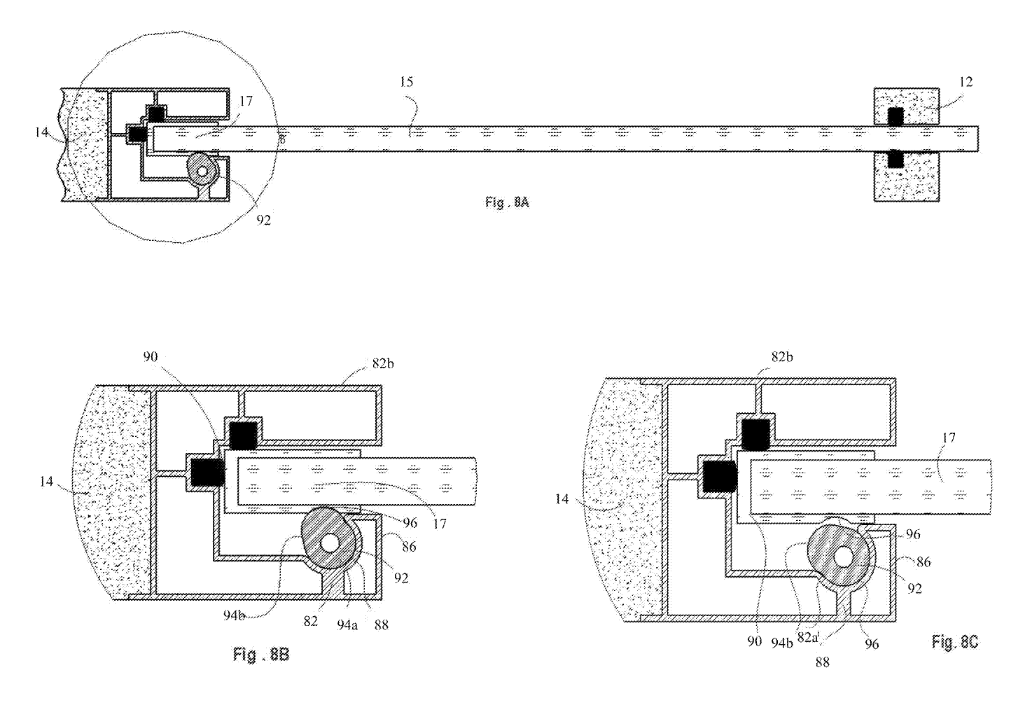

FIG. 8A shows a sliding door 80 having a securing mechanism in accordance with another example of the presently disclosed subject matter. The sliding door 80, for which the same elements as in the previous examples are designated with the same reference numerals, is configured for closing an opening, such as a window, defined between a first profile 12 and a second profile 14. A panel 15 is slidably mounted between first profile 12 and a second profile 14.

As in the sliding doors of the previous examples, the sliding door 80 further includes a holding member coupled to the second profile 14 having a first side portion 82a coupled to a second side portion 82b and being spaced apart from the first side portion 82a defining thereby a channel 24 therebetween. The channel 24 is configured for receiving therein at least a segment 17 of the panel 15. According to the present example, the segment 17 is provided with an engaging edge 90, here illustrated as a U-shaped portion configured to allow insertion of the edge segment 17 of the profile IS therein.

As in the previous example, the holding member 20 further includes an abutting portion 86 transversely extending inside the channel 24 from the first side portion 82a defining an opening between an edge thereof and the second side portion 82b. The opening is configured to allow sliding of the segment 17 therethrough into the channel 24.

According to the present example, the abutting portion 86 and the first side portion 82a define together a rounded seat 88. The rounded seat is configured to hold therein a stop member 92 which can be the same as the one shown in FIGS. 5B and 5C, i.e. having an asymmetric oval cross section. The stop member 92 can thus include a circular portion 94a defined at a first end thereof and a protruding portion 94b defined at the second end thereof. The circular portion 94a is configured to be rotatably disposed inside the seat 88, while the protruding portion 94b protrude out of the seat 88. That is to say, the seat is configured with a shape substantially conforming the outer counter of the circular portion 94a facilitating thereby the rotational displacement of the stop member therein.

The protruding portion 94b is configured to selectively protrude out of the seat 88 in a direction towards the edge segment 17 of the panel 15 or slightly away from the edge segment 17, this way the stop member 92 is selectively shifted between an engaged and disengaged states, as illustrated in FIGS. 8B and 8C respectively.

According to the present example, the engaging edge 90 includes a depression 96 configured to engage the protruding portion 94b in the engaged state thereof. The depression 90 can be configured to further oppose sliding the segment 17 of the panel 15 out of the channel 24. That is to say the depression 90 can be configured to cooperate with the compression forces acting on the panel such that in the engaged state of the stop member the panel 15 is maintained with the segment 17 locked inside the channel 24.

According to another example the stop member can be transversely disposed with respect to the path adjacent a location along the path without a holding portion. For example, the stop member can be pivotally mounted on a hinge extending between a top profile and a bottom profile of a window. The stop member can thus be displaceable between an engaged state in which the stop member engages a segment of the panel precluding thereby sliding of the panel and a disengaged state in which the stop member disengages the segment allowing thereby sliding of the panel.

Those skilled in the art to which the presently disclosed subject matter pertains will readily appreciate that numerous changes, variations, and modifications can be made without departing from the scope of the invention, mutatis mutandis.

1. A sliding door comprising:
a panel configured to slide along a path;
a holding member transversely disposed with respect to said path in a location along said path, said holding member having a first side portion coupled to a second side portion, said second side portion being spaced apart from said first side portion defining thereby a channel therebetween, said channel being configured for receiving therein at least a segment of said panel, said holding member further including an abutting portion transversely extending inside said channel from said first side portion defining an opening between an edge thereof and said second side portion, said opening being configured to allow sliding of said segment therethrough; and
a stop member being displaceable between an engaged state in which a first end of said stop member engages said abutting portion and said first side portion, and a second end of said stop member engages said segment precluding thereby sliding of said panel at least in a direction towards said abutting portion and a disengaged state in which said stop member disengages said segment allowing thereby sliding of said panel towards said abutting portion;
wherein said stop member is configured such that in said engaged state compressive forces are exerted on said segment and said stop member whereby sliding of said panel towards said abutting portion is opposed.

2. The sliding door according to claim 1 wherein said path extends along an opening defined by at least one profile.

3. The sliding door according to claim 2 wherein said holding member is a longitudinal member integrally formed with said at least one profile.

4. The sliding door according to claim 1 wherein said stop member is an elongated rod disposed inside said channel along the length thereof and configured to engage, in said engaged state, at least a portion of said segment.

5. The sliding door according to claim 4 wherein said segment is an edge of said panel extending along one dimension of said panel, said dimension transversely disposed with respect to said path, and wherein said elongated rod is configured to engage at least the majority of said edge.

6. The sliding door according to claim 1 wherein the stop member includes a cross section having a rotational asymmetry configured such that said stop member can be rotated between a first orientation, in which said stop member is in said disengaged state, and a second orientation, in which said stop member is in said engaged state.

7. The sliding door according to claim 6 wherein the stop member is rotatably mounted on a hinge such that an axis of rotation thereof is in parallel with an axis of said rotational asymmetry.

8. The sliding door according to claim 6 wherein said stop member includes a rectangular cross section and is configured to be rotated about an axis between said first orientation and said second orientation, and wherein in said second orientation said rectangular cross section is disposed in an angle with respect to said panel such that a first end of said rectangular cross section engages said abutting portion and said first side portion while a second end of said rectangular cross section engages said segment of said panel.

9. The sliding door according to claim 6 wherein said stop member includes an asymmetric oval cross section having a first end configured to abut said abutting portion and said first side portion, and a second end configured to abut said segment.

10. The sliding door according to claim 9 wherein said asymmetric oval cross section includes a circular portion defined at said first end and a protruding portion defined at said second end, said protruding portion being configured to selectively engage said segment.

11. The sliding door according to claim 10 wherein said segment includes an engaging edge having a depression configured to engage said protruding portion.

12. The sliding door according to claim 10 wherein said abutting portion and said first side portion define together a rounded seat configured to rotatably hold therein said circular portion.

13. The sliding door according to claim 1 wherein said segment includes a shoulder portion facing said stop member and being configured such that in said engaged state a second end of said stop member engages said shoulder portion.

14. The sliding door according to claim 1 further comprising a return mechanism bearing against said stop member and being configured to urge the stop member to said engaged state.

15. The sliding door according to claim 1 further comprising a handle so disposed with respect to said stop member such that it is configured for actuating the displacement of said stop member from said engaged state to said disengaged state.

16. The sliding door according to claim 15 wherein said handle is mounted on said panel adjacent said segment, and is configured to actuate displacement of said stop member from said engaged state to said disengaged state.

17. A securing mechanism for securing a segment of a panel of a sliding door configured to slide along a path, the securing mechanism comprising:
a holding member transversely disposed with respect to the path in a location along the path, said holding member having a first side portion coupled to a second side portion, said second side portion being spaced apart from said first side portion defining thereby a channel therebetween, said channel being configured for receiving therein at least the segment of the panel, said holding member further including an abutting portion transversely extending inside said channel from said first side portion defining an opening between an edge thereof and said second side portion, said opening being configured to allow sliding of the segment therethrough; and
a stop member being displaceable between an engaged state in which a first end of said stop member engages said abutting portion and said first side portion and a second end of said stop member is configured to engage the segment precluding thereby sliding of the panel at least in a direction towards said abutting portion and a disengaged state in which said stop member is configured to disengage the segment allowing thereby sliding of said panel towards said abutting portion;
wherein said stop member is configured such that in said engaged state compressive forces are exerted on the segment and said stop member whereby sliding of said panel towards said abutting portion is opposed.

18. A sliding door comprising:
a panel configured to slide along a path;
a stop member transversely disposed with respect to said path adjacent a location along said path, said stop member being pivotally mounted on an axis, and being displaceable between an engaged state in which said stop member engages a segment of said panel precluding thereby sliding of said panel and a disengaged state in which said stop member disengages said segment allowing thereby sliding of said panel;
wherein said stop member is configured such that in said engaged state compressive forces are exerted on said segment by said stop member whereby sliding of said panel towards said abutting portion is opposed.

19. The sliding door according to claim 18 wherein said stop member is mounted on said panel and configured to slide therewith along said path; and
wherein said sliding door further can include a holding member transversely disposed with respect to the path in a location along the path, said holding member having a first side portion coupled to a second side portion, said second side portion being spaced apart from said first side portion defining thereby a channel therebetween, said channel being configured for receiving therein at least the segment of the panel, said holding member further including an abutting portion transversely extending inside said channel from said first side portion defining an opening between an edge thereof and said second side portion, said opening being configured to allow sliding of the segment therethrough; and
wherein in said engaged state first end of said stop member engages said abutting portion and said first side portion and a second end of said stop member engages said segment precluding thereby sliding of the panel at least in a direction towards said abutting portion, and wherein in said disengaged state said stop member is configured to disengage the segment allowing thereby sliding of said panel towards said abutting portion.
